(19) United States
(12) Patent Application Publication
(10) Pub. No.: US 2004/0257799 A1
(43) Pub. Date: Dec. 23, 2004

(54) Stretchable and shrinkable tree light strings

(76) Inventor: Joseph Yao, Taipei (TW)

Correspondence Address: MCGLEW & TUTTLE, PC, 1 SCARBOROUGH STATION PLAZA, SCARBOROUGH, NY, 10510-0827, US

(21) Appl. No.: 10/677,915

(22) Filed: Oct. 2, 2003

(30) Foreign Application Priority Data
Mar. 11, 2003 (CN) 03238504.8

(51) Int. Cl. F21S 6/00; F21V 21/00

(52) U.S. Cl. 362/123; 362/391; 362/249; 362/806

(57) ABSTRACT

A stretchable and shrinkable tree light string including: long trunk: composing of many short pipes, the short pipes having one or many connecting ring; base frame: having the central axis to support long trunk to stand up right straight; multiple branches: connecting one end of pin with the connecting ring on the short pipe, to use the connecting ring as base point, the other end of branches being the center of the long trunk to be able to stretch out to form a tree shape, also to be able to fold up to reduce the volume; single or many sets of light string: composed of many lamp bulbs, lamp holders, electrical conductors and receptacles, to be fixed on the branches to establish tree light strings.

### BACKGROUND OF THE INVENTION

A conventional lamp light string set in a Christmas light string is consisting of a lamp bulb, lamp base, lamp holder, multiple electrical conductors, receptacles or flasher control, wherein the electrical conductors can be single or double or more than two wound into an electrical circuit. The distributed conductors can be formed in one, two or more than two electrical conductors, such as the FIG. 4 of U.S. Pat. No. 4,241,387 and the FIGS. 1 and 2 of the prior art in this case. In general, it is to use said electrical conductors to be wound in the trees. Such is troublesome and monotonous. Further, such kind of work is used several years. The present invention is an improvement in the defects of the conventional products. It is to use artificial trunks and branches of tree to make the decorative light strings along with the electrical connectors wound on the trees, so that the decorative light strings and branches of trees are to form a shape so as to obtain a decorative effect.

### SUMMARY OF THE INVENTION

The present invention is to make a conventional Christmas light strings be easy to transport and to make an improvement in the defects of the conventional products. The present invention is to use a kind of stretchable and shrinkable tree light strings, including a long trunk to be composed of many short pipes, the short pipe has one or many connecting ring; base frame has central axis to support long trunk to stand up right straight; multiple branches connect one end with the connecting ring on the short pipe, to use the connecting ring as the base point, the other end of the branch is the center of the trunk to be able to stretch out to form a tree shape and also can be folded up to reduce the volume; single or multiple sets of light strings, composed of many lamp bulbs, lamp holders, electrical conductors and receptacles, to be fixed on the branches to establish tree light strings.

The present invention is to provide stretchable and shrinkable tree light strings and its characteristic is to use connecting ring on the short pipe, surrounding and containing the fixed circumferentially outer edge of short pipe, extending many vanes and connecting with branches.

The present invention relates to stretchable and shrinkable tree light strings and its characteristic is at the side of the vane having hole on the connecting ring whereby to connect with branch.

The present invention relates to stretchable and shrinkable tree light strings and its characteristic is to use the base part of branches to form a round shape, there is a hole on the central part for convenient to connect with connecting ring.

The present invention relates to stretchable and shrinkable tree light strings and its characteristic is the base part of branch to be put between two vanes, to aim at each other the hole, to use the pin from one end of the vane going through its hole, then going through the hole of the base part of branch to another hole of the vane. The pin is fixed and the pin is used as an axis to make branches being stretchable and shrinkable freely.

The present invention relates to stretchable and shrinkable tree light strings and its characteristic is to use the pin as a screw and screw cap, after the screw going through said several holes, the screw cap is fastened and fixed tightly.

The present invention relates to stretchable and shrinkable tree light strings and its characteristic is the pin being twin head having flange. One end of said twin head has a horizontal ditch to divide the flange into two half, then compress these two half flange to make the outside diameter of two half flange be reduced. After going through the holes of the vane and branches, flange is restored to stretch. Two heads of the flange are to wedge twin vanes, so that the branches are not loosed.

The present invention relates to stretchable and shrinkable tree light strings and its characteristic is to use light string attached to the protection device, transformer or functional control device to increase decorative function.

The present invention relates to stretchable and shrinkable tree light strings. It is another kind of stretchable and shrinkable tree light strings including a long trunk to be composed of many short pipes, the short pipe has one or many connecting ring; base frame has the central axis to support long trunk to stand up right straight; multiple branches and base part of the branch to form a round shape and there is a hole on the central part between two vanes, to aim at each other the hole, to use the pin from one end of the vane going through its hole, then going through the hole of the base part of branch to another hole of the vane. The pin is fixed and the pin is used as an axis to make branches being stretchable and shrinkable freely; single or multiple sets of light strings: composed of many lamp bulbs, lamp holders, electrical conductors and receptacles, to be fixed on the branch to establish tree light strings.

### BRIEF DESCRIPTION OF THE DRAWINGS

The detailed descriptions are done accompanying the drawings and preferred embodiments of the present invention:

FIG. 1 is a perspective view with 3-dimention showing the practical structure of the stretchable and shrinkable tree light strings of the present invention.

FIG. 2 is a perspective view of the preferred embodiment of the connection style of the stretchable and shrinkable tree light strings of the present invention;

FIG. 3 is a perspective view showing the structure of short pipe of the present invention; FIG. 3A is a cross section view of the connecting ring on the short pipe of the present invention.

FIG. 4 is a perspective view of the connection position of the connecting ring on the short pipe and branches in the present invention.

FIG. 5 is a perspective view of the structure of long trunk and light string of the present invention.

FIG. 6 is a perspective view of single or multiple branches of a further embodiment of the present invention.

FIG. 7 is a perspective view of the pin or the screw and screw cap of the present invention; FIG. 7A is the structure of the screw and screw cap; FIG. 7B is the structure of the pin.

### DETAILED DESCRIPTION OF THE PREFERRED EMBODIMENTS

For the convenience of the description, the same composing part is to show the same number in the drawings.

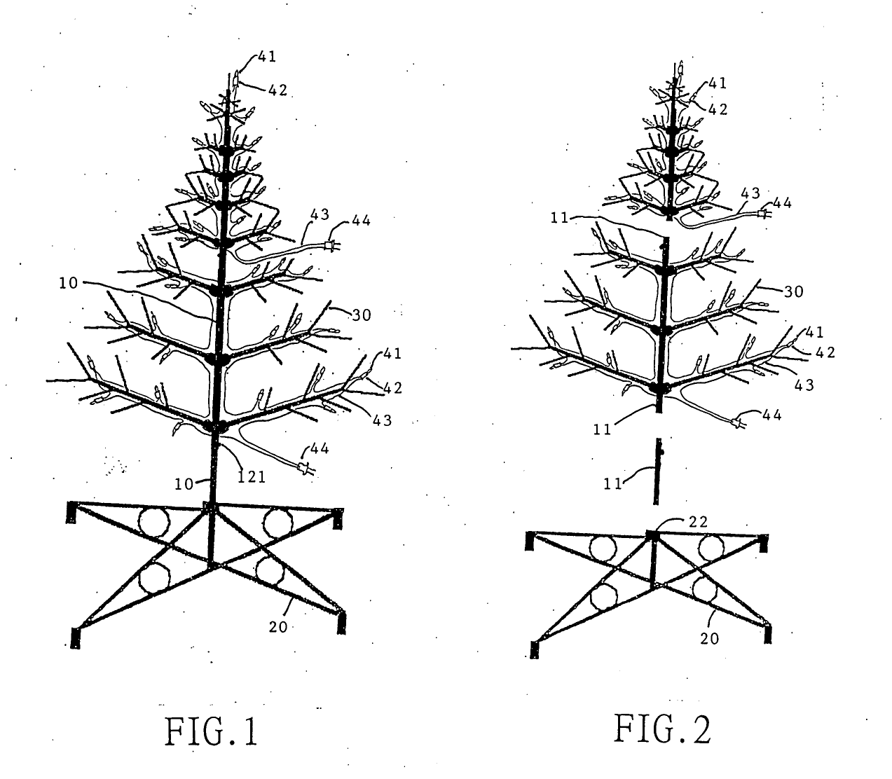

Now, referring to FIG. 1, it is a perspective view of the stretchable and shrinkable tree light strings of the present invention. The light string set of the present invention includes long trunk 10, connected with many short pipes 11. Said short pipe 11 has one or many connecting ring 12 with flange 121; base frame 20, having central axis 22 to support long trunk 10 standing up right; branches 30, using one end of pin 50 to connect with connecting ring 12 on the short pipe. Said connecting ring 12 is used as base point, and the other end of branch 30 is to use the long trunk 10 as center to expand and form a tree shape, also can be folded up to reduce the volume; single or many sets light strings 40, composed of lamp bulb 41, lamp holder 42, electrical conductor 43 and receptacle 44, fixed on the branches to form tree lamp.

FIG. 2 relates to the connection style of the stretchable and shrinkable tree light strings of the present invention. The base frame 20 has central axis part 22, to be able to support long trunk standing up right, between long trunk and base frame, a hollow short pipe 11 having not attached with branches is provided in the light string to increase the distance between the light string and supporting face. There are many branches 30 connected on the long trunk.

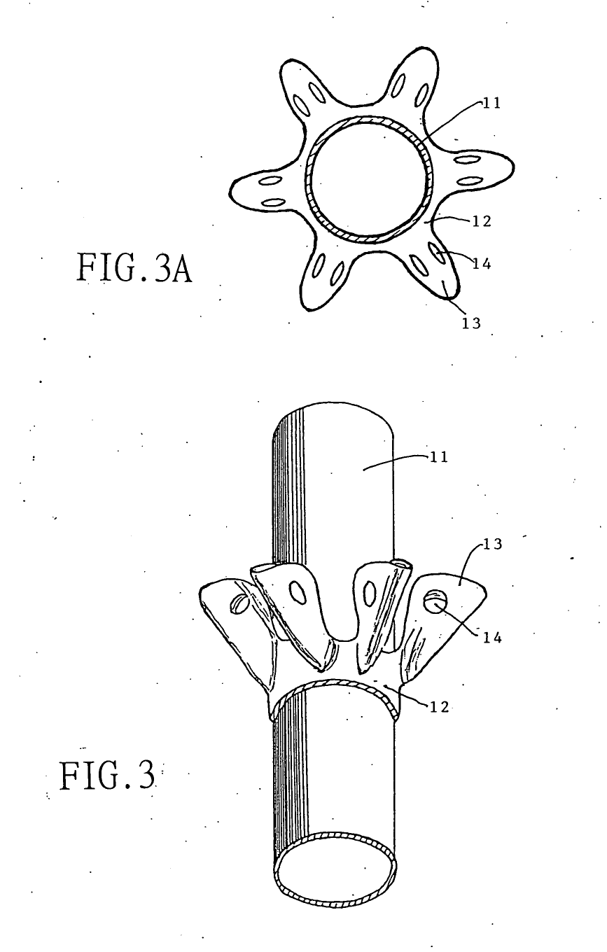

FIG. 3 is a perspective view showing the structure of short pipe of the present invention. The connecting ring 12 on the short pipe 11 is used to surround and contain the fixed circumferentially outer edge of short pipe, extending many vanes 13 and connecting with branches 30.

FIG. 3A is a cross section view of the connecting ring on the short pipe of the present invention. The connecting ring 12 is surrounding the outer edge of short pipe 11. It is to use the hole 14 located on the lateral side of vane 13 of the connecting ring 12 to connect with branch.

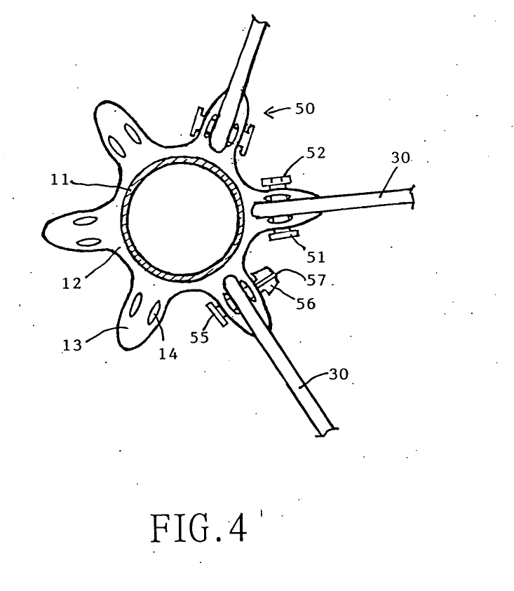

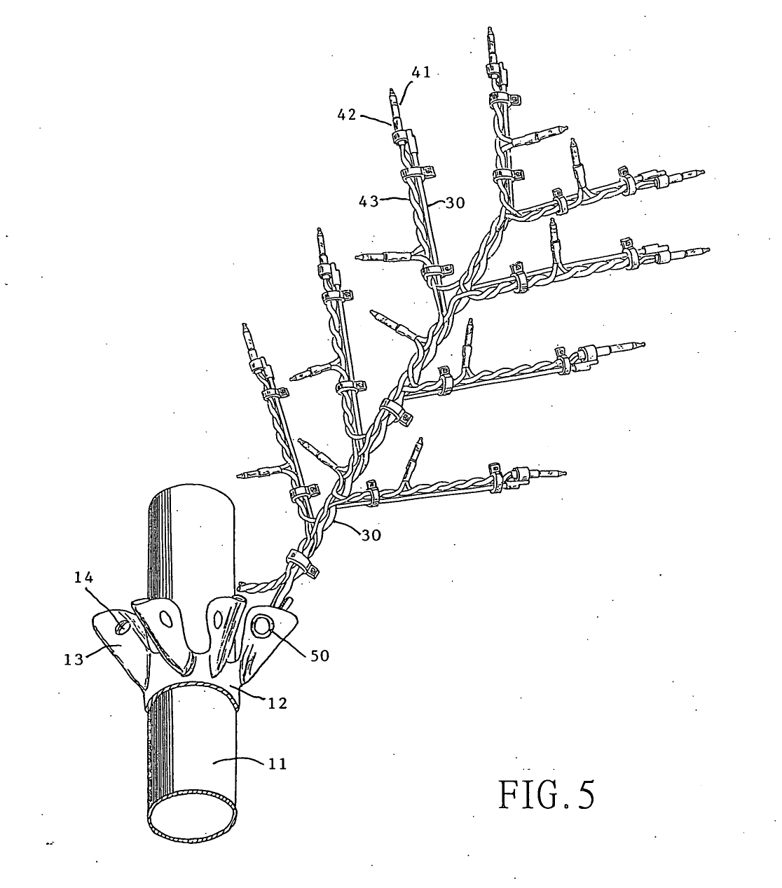

FIG. 4 is a perspective view of the connection position of the connecting ring on the short pipe and branches in the present invention. The branch base part 31 is put between two vanes 13, the hole 14 is to aim each other, the pin 50 from one end of the vane goes through its hole, then goes through the hole of the branch base part to another hole of the vane, and fixes the pin, and uses the pin 50 as axis to make branches be stretchable and shrinkable freely.

FIG. 5 is a perspective view of the structure of long trunk and light string of the present invention. The long trunk is composed of many short pipes 11, connecting ring 12 attached to short pipe 11. The connecting ring 12 has vane 13 which equipped with hole 14. It is to use many pillared branches 30, and its base part is to form an annular shape with a hole in the center. Put connecting ring 12 in between vane 13, use one end of pin to go through the hole on the vane, and fix it through the hole on the branch. The pin is used an axis, and a single or many sets light string on the branch is used. Said light string is composed of many lamp bulb 41, lamp holder 42, electrical conductor 43 and receptacle. The fix device is used and fixed on the branch. Said fix device is able to use movable clip 62 to fix light string on the tree lamp so as to establish decorative tree lamp. Besides, the branch 30 is also able to use a single pillar.

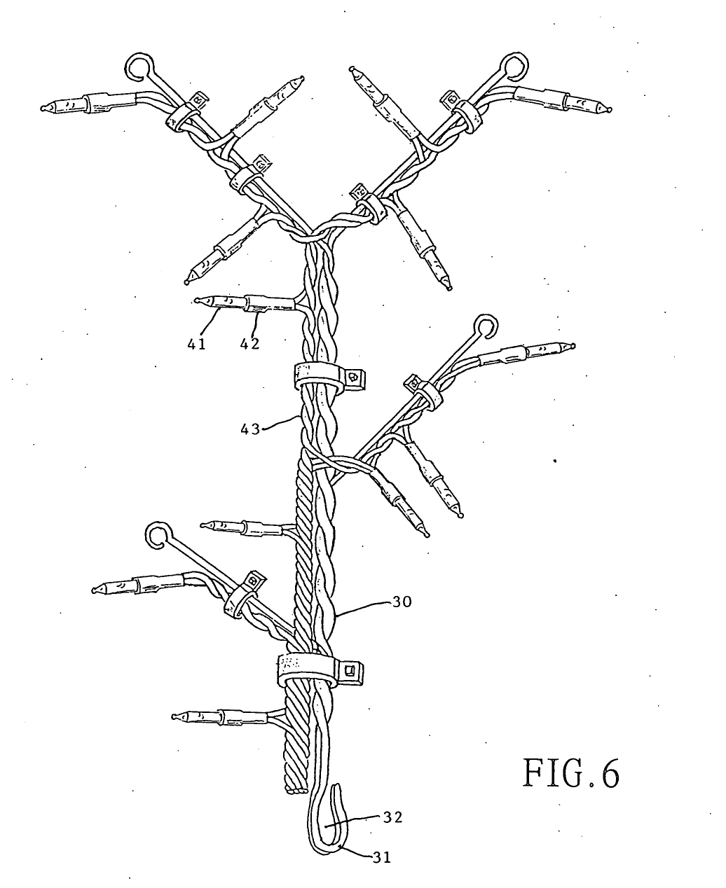

FIG. 6 is a structure of further embodiment of a single or multiple branches of the present invention. The base part 31 of branch 30 is to form an annular shape. The center of said shape is a hole 32. Said base part is put between two vanes on the connecting ring, and use one end of pin going through the hole on the vane, and fix it through the hole on the branch. Said pin is used as an axis and the other end of the branch is to use long trunk as center. It is able to expend into tree shape and also can be folded up to reduce the volume.

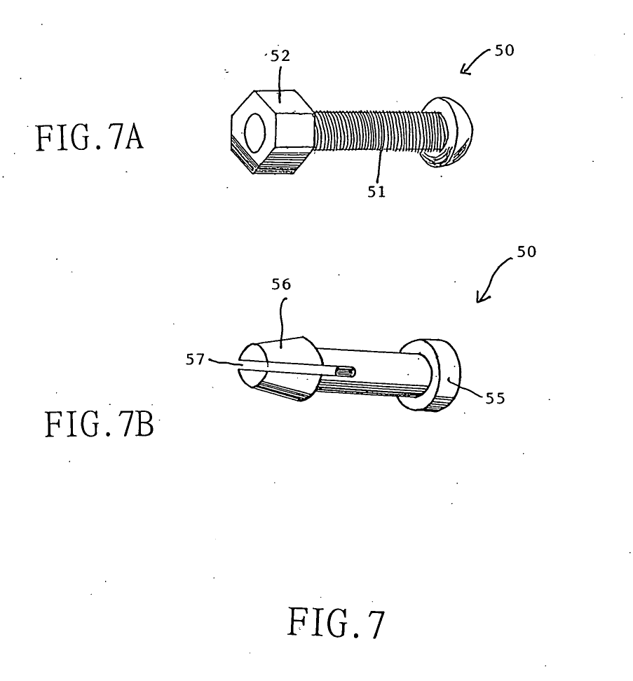

FIG. 7 is a structural drawing of the pin or the screw and screw cap of the present invention. FIG. 7A is the structural drawing to use screw 51 and screw cap 52. The pin 50 is to use screw 51 and screw cap 52. FIG. 7B is use pin 50 as twin head having protuberance 55, 56, its one end has horizontal ditch 57, divided the protuberance into two parts, compressed these two half parts of protuberance, made the outside diameter of two half parts of protuberance to be reduced, after going through holes of the vane and branches, the protuberance restored to expand. The two head protuberances are used to wedge twin vanes, so that the branches are not loose.

From the foregoing it will be appreciated that although specific embodiments of the invention have been described herein for purposed of illustration, various modifications and improvements thereon will become readily apparent to those skilled in the art. Accordingly, the appended claims are to be construed broadly and in a manner consistent with the spirit and scope of the invention described herein.

Symbol Lists

| | |
|---|---|
| 1 | light string set |
| 10 | long trunk |
| 11 | short pipe |
| 12 | connecting ring |
| 121 | flange |
| 13 | vane |
| 14 | hole |
| 20 | base frame |
| 22 | central axis part |
| 30 | multiple branches |
| 31 | base part |
| 32 | hole |
| 40 | single or many set light string |
| 41 | lamp bulb |
| 42 | lamp holder |
| 43 | electrical conductor |
| 44 | receptacle |
| 50 | pin |
| 51 | screw |
| 52 | screw cap |
| 55, 56 | protuberance |
| 57 | horizontal ditch |

What I claimed is:

1. A stretchable and shrinkable tree light string including:
long trunk: composing of many short pipes, the short pipes having one or many connecting ring;
base frame: having the central axis to support long trunk to stand up right straight;
multiple branches: connecting one end of pin with the connecting ring on the short pipe, to use the connecting ring as base point, the other end of branches being the center of the long trunk to be able to stretch out to form a tree shape, also to be able to fold up to reduce the volume;
single or many sets of light string: composed of many lamp bulbs, lamp holders, electrical conductors and receptacles, to be fixed on the branches, to establish tree light strings.

2. A stretchable and shrinkable tree light string as claimed in claim 1, wherein using connecting ring on the short pipe, surrounding and containing the fixed circumferentially outer edge of short pipe, extending many vanes and connecting with branches.

3. A stretchable and shrinkable tree light string as claimed in claim 1, wherein at the side of the vane having hole on the connecting ring whereby to connect with branch.

4. A stretchable and shrinkable tree light string as claimed in claim 1, wherein using the base part of branches to form a round shape, a hole being on the central part for convenient to connect with connecting ring.

5. A stretchable and shrinkable tree light string as claimed in claim 1, the base part of branch to be put between two vanes, to aim at each other the hole, to use the pin from one end of the vane going through its hole, then going through the hole of the base part of branch to another hole of the vane, the pin being fixed and used as an axis to make branches being stretchable and shrinkable freely.

6. A stretchable and shrinkable tree light string as claimed in claim 5, wherein the pin to be used as a screw and screw cap, after the screw going through said several holes, the screw cap being fastened and fixed tightly.

7. A stretchable and shrinkable tree light string as claimed in claim 5, wherein the pin being twin head having flange, one end of said twin head having a horizontal ditch to divide the flange into two half, then compressing these two half flange to make the outside diameter of two half flange be reduced, after going through the holes of the vane and branches, flange being restored to stretch, two heads of the flange to wedge twin vanes, so that the branches being not loosed.

8. A stretchable and shrinkable tree light string as claimed in claimed 1, wherein using light string attached to the protection device, transformer or functional control device to increase decorative function.

9. A stretchable and shrinkable tree light strings including:
long trunk: composing of many short pipes, the short pipe has one or many connecting ring;
base frame: having the central axis to put support long trunk to stand up right straight;
multiple branches: base part of the branch to form a round shape and a hole being on the central part between two vanes, to aim at each other the hole, to use the pin from one end of the vane going through its hole, then going through the hole of the base part of branch to another hole of the vane, the pin being fixed and used as an axis to make branches being stretchable and shrinkable freely;
single or multiple sets of light strings: composed of many lamp bulbs, lamp holders, electrical conductors and receptacles, to be fixed on the branch to establish tree light strings.
